(19) United States
(12) Patent Application Publication
(10) Pub. No.: US 2014/0211002 A1
(43) Pub. Date: Jul. 31, 2014

(54) Video Object Detection System Based on Region Transition, and Related Method

(71) Applicant: QNAP SYSTEMS, INC., New Taipei City (TW)

(72) Inventors: Horng-Horng Lin, New Taipei City (TW); Chan-Cheng Liu, New Taipei City (TW)

(73) Assignee: QNAP SYSTEMS, INC., New Taipei City (TW)

(21) Appl. No.: 13/845,107

(22) Filed: Mar. 18, 2013

(30) Foreign Application Priority Data
Jan. 31, 2013 (CN) 201310039243.1

(51) Int. Cl. H04N 7/18

(52) U.S. Cl. CPC H04N 7/181
USPC 348/143

(57) ABSTRACT

A video object detection system based on region transition includes a video acquiring unit, a user interface unit and a control module. The video acquiring unit is utilized for acquiring a video frame. The user interface unit is configured to provide a user to define at least one detection region with a set of image pixels on the acquired video frame and to define at least one region transition rule for identifying video objects of interest. Each detection region is represented with a set of image pixels. The control module is utilized for detecting position of a target video object and determining whether a moving trajectory of the target video object matches the at least one region transition rule.

### BACKGROUND OF THE INVENTION

1. Field of the Invention

The present invention relates to a video object detection system and related method, and more particularly, to a video object detection system and related method based on region transition.

2. Description of the Prior Art

Video object detection and counting techniques have widely been applied in various fields, such as factory monitoring, military surveillance, building security surveillance, etc. In a video surveillance application, pedestrians or vehicles can be detected and calculated via acquired video frames, so that a monitoring person is capable of obtaining various information data, such as traffic jams, traffic violations, pedestrian flow of shopping malls, etc, for the following control and analysis process.

A conventional video object detection and counting system usually adopts a “detection line” for acting as a system detection interface. For example, U.S. Pat. No. 6,696,945 and No. 6,970,083 disclose a method for implementing a “video tripwire” as a video object detection and counting interface. When a target object passes through a predetermined video tripwire, a corresponding counter may be triggered to count the passing event. However, for a complicated monitoring scene, the conventional video object detection and counting system with line-based interface may require to establish a lot of detection lines and set detection directions of each detection line for counting video objet moving from a first region to a second region. In short, such a line-based method would incur longer setting time and more complex computations, and thus causing inconvenience for the user.

### SUMMARY OF THE INVENTION

Therefore, the primary objective of the invention is to provide a video object detection system and related method based on region transition.

An embodiment of the invention discloses a video object detection system based on region transition includes a video acquiring unit, a user interface unit and a control module. The video acquiring unit is utilized for acquiring a video frame. The user interface unit is configured to provide a user to define at least one detection region with a set of image pixels on the acquired video frame and to define at least one region transition rule for identifying video objects of interest. Each detection region is represented with a set of image pixels. The control module is utilized for detecting position of a target video object and determining whether a moving trajectory of the target video object matches the at least one region transition rule.

An embodiment of the invention further discloses a video object detection method based on region transition. The video object detection method includes acquiring a video frame; providing a user to define at least one detection region with a set of image pixels on the acquired video frame and to define at least one region transition rule for identifying video objects of interest via a user interface unit, wherein each detection region is represented with a set of image pixels; detecting position of a target video object and determining whether a moving trajectory of the target video object matches the at least one region transition rule.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams of detection regions each having a set of image pixels under different density according to exemplary embodiments of the present invention.

FIG. 3 is a schematic diagram of a video object detection system based on region transition according to an exemplary embodiment of the present invention.

FIG. 4 and FIG. 5 are schematic diagrams of defining detection using graphical user interface according to exemplary embodiments of the present invention.

FIG. 6 is a schematic diagram of a user interface for drawing a sparse region template from Voronoi diagram according to an exemplary embodiment of the present invention.

FIG. 7 is a schematic diagram of detecting video object according to an exemplary embodiment of the present invention.

FIG. 8 is a schematic diagram of a procedure according to an embodiment of the present invention.

FIG. 9 is a schematic diagram of moving trajectory of the target video object according to an exemplary embodiment of the present invention.

FIG. 10 is a schematic diagram of defining region transition rule using graphical user interface according to an exemplary embodiment of the present invention.

### DETAILED DESCRIPTION

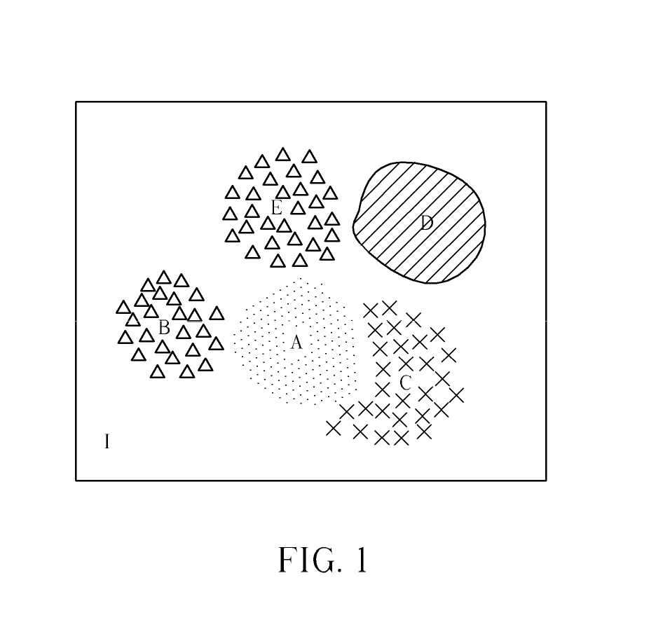

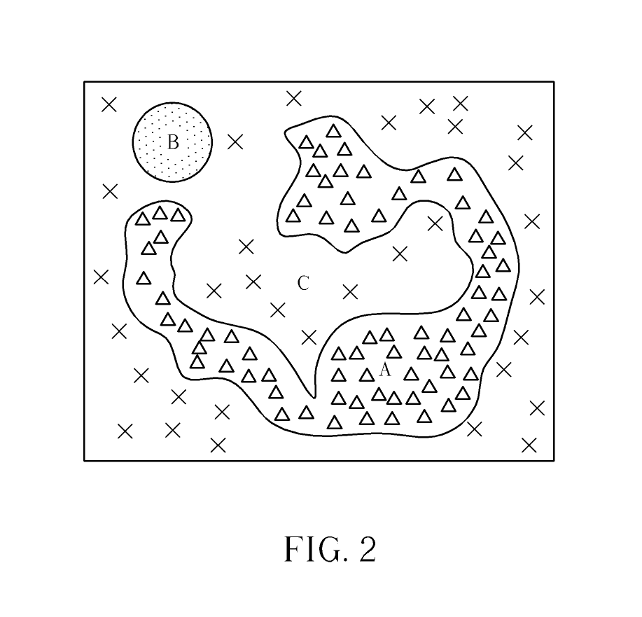

The invention provides a video object detection system based on region transition. Please refer to FIG. 1 and FIG. 2 which are schematic diagrams of detection regions each having a set of image pixels under different density according to exemplary embodiments of the present invention. As shown in FIG. 1, an image frame I is divided into regions A to E. Each detection region can be represented with a set of image pixels. Density of the set of image pixels for each detection region may be dense or sparse. There may be neighboring regions or separate regions between two detection regions. In other words, the invention utilizes a representation method of a sparse point set for the video object detection so as to reduce complexity of computations.

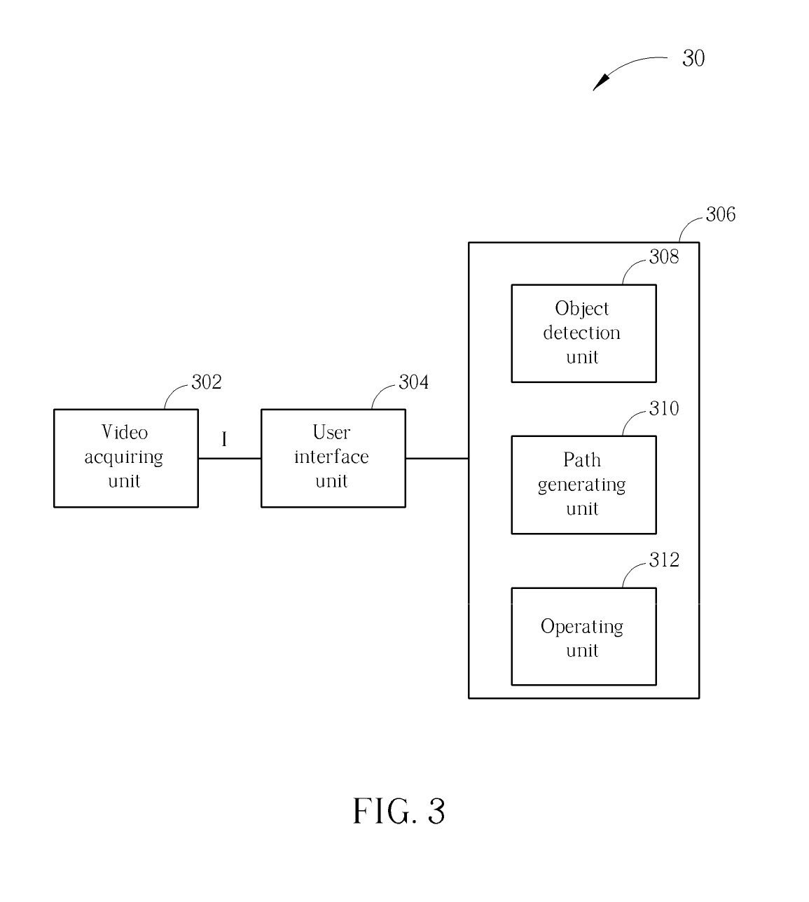

Please refer to FIG. 3, which is a schematic diagram of a video object detection system 30 based on region transition according to an exemplary embodiment of the present invention. As shown in FIG. 3, the video object detection system 30 includes a video acquiring unit 302, a user interface unit 304 and a control module 306. The video acquiring unit 302 is utilized for acquiring a video frame I. The video frame I includes a plurality of image pixels. The user interface unit 304 is configured to provide a user to define at least one detection region with a set of image pixels on the acquired video frame I and define at least one region transition rule for identifying video objects of interest. Each detection region can be represented with a set of image pixels. The control module 306 is utilized for detecting position of a target video object and determining whether a moving trajectory of the target video object matches the at least one region transition rule defined by the user, so as to generate a determining result. Furthermore, the control module 306 includes an object detection unit 308, a path generating unit 310 and an operating unit 312. The object detection unit 308 is utilized for detecting position of the target video object in the video frame I and accordingly generating a position detecting result. The path generating unit 310 is utilized for generating a region transition path, i.e. the moving trajectory, corresponding to the target video object according to the position detecting result. The operating unit 312 is utilized for determining whether the region transition path, i.e. the moving trajectory, conforms to the at least one region transition rule defined by the user, so as to generate a determining result.

Moreover, please further refer to FIG. 1. In this embodiment, the user interface unit 304 is configured to provide a user to define detection regions. During system operation, each of the detection regions A to E can be represented with a set of image pixels, respectively. Density of the set of image pixels for each detection region may be dense or sparse. The user can adjust the density of the said set of the image pixels for each detection region via the user interface unit 304. For example, the said set of the image pixels may include a representative image pixel of the corresponding detection region. The said set of the image pixels may include all image pixels of the corresponding detection region. In addition, the user interface unit 304 can label the defined detection region with region labels automatically.

On the other hand, the user interface unit 304 further includes a detection region drawing module. The detection region drawing module is utilized for providing the user to draw each detection region on the video frame I and select density of the set of the image pixels for each detection region. As such, the user can define the detection region on the video frame I via the detection region drawing module acting as an input interface. Furthermore, the detection region drawing module further includes a free hand drawing sub-module. The free hand drawing sub-module is utilized for providing the user to draw a detection region in a free-form shape. The free hand drawing sub-module is also utilized for providing the user to select density of the set of the image pixels for the detection region. For example, the user can use a touch pen to draw three regions on the video frame I, such as the detection regions A, B and O shown in FIG. 2, for establishing the required detection regions.

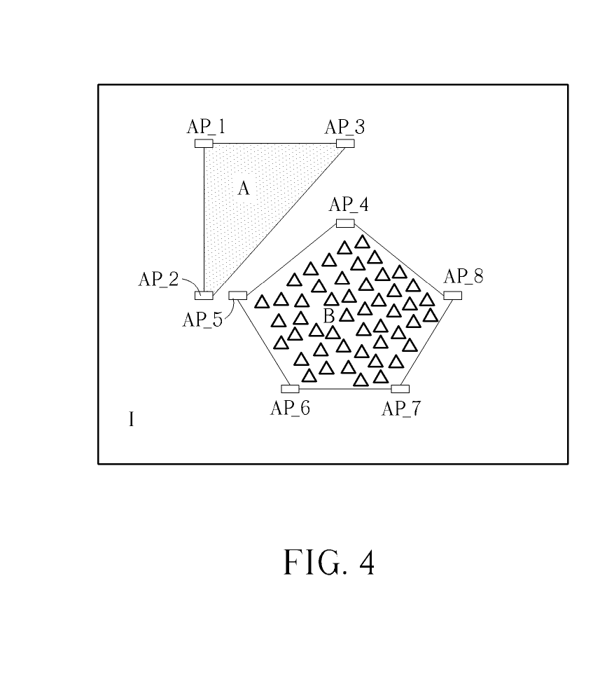

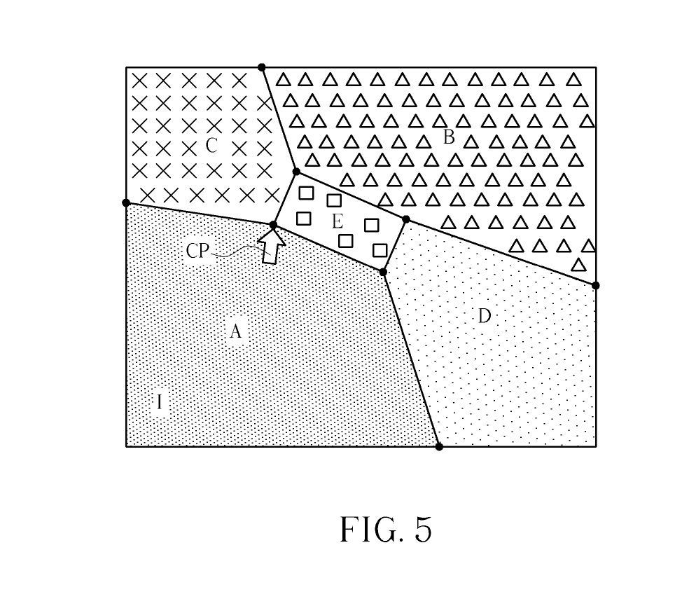

The detection region drawing module further includes an anchor point selection module. The anchor point selection module is utilized for providing the user to draw a detection region in a polygon shape and select density of the set of the image pixels for the detection region. For example, please refer to FIG. 5. The user can use an input device to click and drag anchor points on the user interface unit 304 so as to select a required detection region. Please refer to FIG. 4. The user can use an input device to click anchor points SP_1 to AP_3 to create a detection region A. The user can also use the input device to click anchor points AP_4 to AP_8 to create a detection region B.

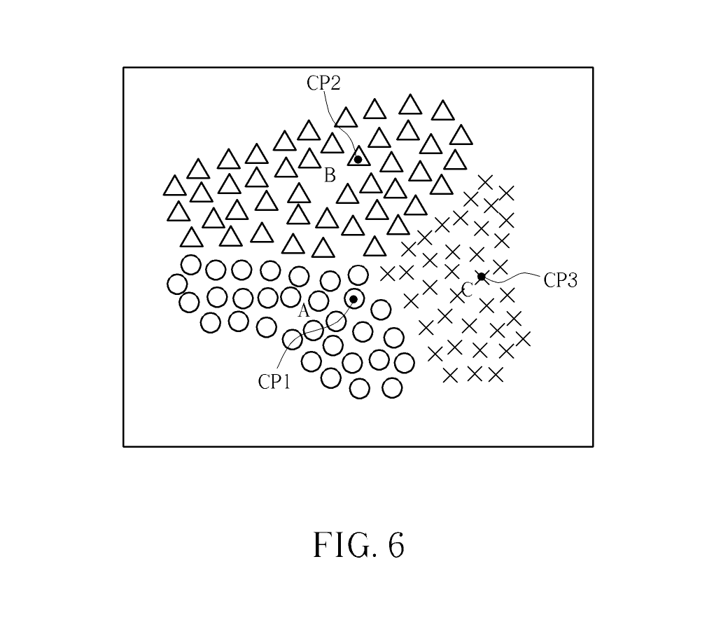

The detection region drawing module further includes a region template adjusting sub-module. The region template adjusting sub-module is utilized for providing the user to draw a detection region in a region partition corresponding to a specific template by adjusting control points of a region template and select density of the set of the image pixels for the detection region. Please refer to FIG. 5. The user can use an input device to adjust a predetermined region template so as to select a required detection region. For example, the user can use the input device to move, rotate or scale the predetermined region template. As shown in FIG. 5, the user can use the input device to click a control point CP to adjust the size of a region partition, so as to create detection region A to E. Please refer to FIG. 6. FIG. 6 is a schematic diagram of a user interface for drawing a sparse region template from Voronoi diagram according to an exemplary embodiment of the present invention. As shown in FIG. 6, the user can click and drag control points CP1 to CP3. After computing based on Voronoi diagram algorithm, the video frame I can be divided into several detection regions and corresponding detection regions can be labeled with region labels automatically. In such a situation, the user can further set the density of the set of the image pixels for each detection region by rolling a mouse wheel. Besides, the set of the image pixels for each detection region can be recorded by system.

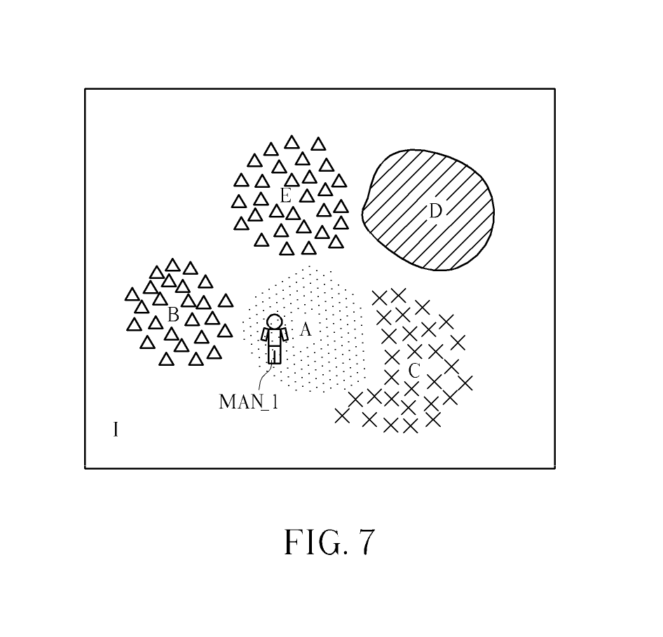

Furthermore, after the detection regions are defined, the object detection unit 308 detects position of the target video object in the video frame I and determines whether the target video object locates in the defined detection regions. For example, please refer to FIG. 3 and FIG. 7. after the video frame I is acquired by the video acquiring unit 302, the user can utilized the user interface unit 304 to define detection regions A to E on the on the video frame I. As shown in FIG. 7, the object detection unit 308 can detect the position of a target video object MAN_1 in the video frame I and determine that the target video object is located in the detection region A. In such a situation, the position detecting result indicates the target video object is located in the detection region A. In other words, the video object detection system 30 is capable of determining location of the target video object based on the defined detection region of the video frame. Since each of the defined detection regions is formed with a set of image pixels in the video frame I, the object detection unit 308 can determine whether the target video object locates on the image pixels of the defined detection region for determining the location of the target video object. For example, as shown in FIG. 7, when the object detection unit 308 detects the target video object MAN_1 is on the image pixel of the detection region A, the position detecting result indicates the target video object MAN_1 is located in the detection region A.

In brief, since the conventional video object detection and counting system usually adopts a “detection line” for acting as a system detection interface, the conventional system may require to establish a lot of detection lines and set detection directions of detection lines for counting, thus, incurring longer setting time and more complex computations, and causing inconvenience for the user. In comparison, the invention utilizes a representation method of a sparse point set for the video object detection so as to reduce complexity of computations. Moreover, the invention provides a more rapid and convenient way for the user to define detection regions via the user interface unit and determine the position of the target video object via the corresponding image pixels, and thus reducing operation time and enhancing convenience for the user.

Note that, the video object detection system 30 shown in FIG. 3 is an exemplary embodiment of the present invention and those skilled in the art can make alternations and modifications accordingly. For example, the user can input a region setting value for dividing the image frame into multiple detection regions and adjust the divided detection regions via the detection region drawing module. Moreover, Density of the set of image pixels for each detection region may be dense or sparse. In addition, there may be neighboring regions or separate regions between two detection regions defined by the user. In addition, the above-mentioned input device may be a mouse, a touch pen, or a touch screen, and this should not be a limitation of the present invention.

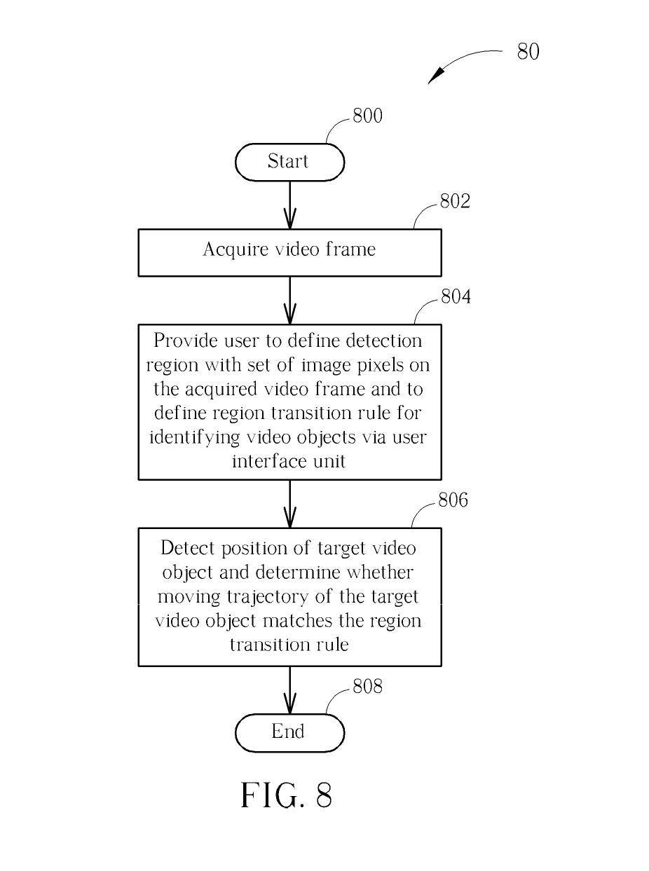

Operations of video object detection method for the video object detection system 30 may be summarized in an exemplary procedure 80, please refer to FIG. 8.

FIG. 8 is a schematic diagram of a procedure 80 according to an embodiment of the present invention. The procedure 80 comprises the following steps:

Step 800: Start.

Step 802: Acquire video frame.

Step 804: Provide user to define detection region with set of image pixels on the acquired video frame and to define region transition rule for identifying video objects via user interface unit.

Step 806: Detect position of target video object and determine whether moving trajectory of the target video object matches the region transition rule.

Step 808: End.

Related variations and the detailed description can be referred from the foregoing description, so as not to be narrated herein.

In addition, as mentioned above, the user can define the detection regions via the user interface unit 304. Moreover, the user can also define the region transition rules via the user interface unit 304 for the following surveillance of object motion and behaviors.

Furthermore, the user interface unit 304 further includes a region transition rule setting module. The region transition rule setting module is utilized for providing the user to set at least one region transition rule according to detection region labels. The region transition rule setting module includes a graphical drawing region transition sub-module. The graphical drawing region transition sub-module is utilized for providing the user to draw region transition paths via a graphical user interface. The graphical drawing region transition sub-module is further utilized for providing the user to set region transition labels and region transition exclusion labels via the graphical user interface. The graphical drawing region transition sub-module is also utilized for providing the user to input other parameters of the at least one region transition rule on free hand drawing paths. The region transition rule setting module further includes a text input region transition sub-module. The text input region transition sub-module is also utilized for providing the user to set region transition labels and region transition exclusion labels via a specific text input format. The text input region transition sub-module is also utilized for providing the user to input other parameters of the at least one region transition rule on text label paths.

For example, the region transition rule includes, but is not limited to, at least one of the followings: an object type parameter, a region transition label parameter, a time period parameter, and a region transition exclusion parameter. The object type parameter is utilized for providing the user to assign specific object types for acting as detection targets of region transitions. The region transition label parameter is utilized for providing the user to label sequence of region transitions. The time period parameter is utilized for providing the user to set video objects occurring region transitions during a detection period. The region transition exclusion parameter is utilized for providing the user to assign exclusion conditions of the region transitions.

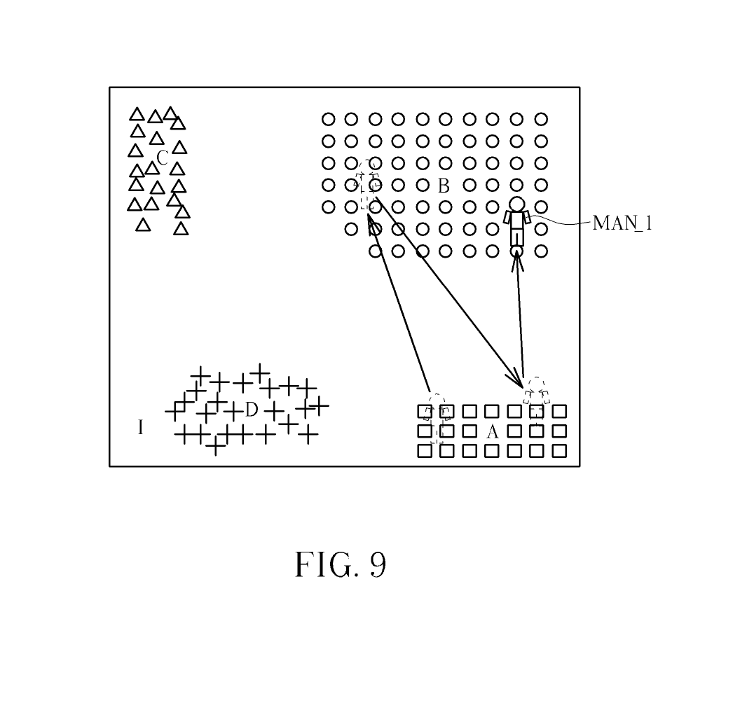

Please refer to FIG. 9. If the region transition rule includes the object type parameter, the region transition label parameter, and the time period parameter. The region transition rule is expressed as “MAN_1; 60 seconds; A→B→A→B”. This means, the video object detection system 30 can detect whether the transition path of the target video object MAN_1 matches the region transition label parameter “A→B→A→B” in sixty seconds. During the detection operation, the video acquiring unit 302 is able to acquire video frames successive for providing the following region transition situations of the target video object. Besides, the user can use the user interface unit 304 to define detection regions A to D on the video frame. Suppose the detection region A is an entrance and exit zone of a shopping mall, the detection region B is a commodity zone of the shopping mall, the detection region C is a warehouse zone of the shopping mall, and the detection region D is a check-out zone of the shopping mall. In this embodiment, there may be neighboring regions or separate regions between two detection regions. Furthermore, the user can use the user interface unit 304 to input the above-mentioned region transition rule. After that, the object detection unit 308 can detect the position of the target video object MAN_{—}1. The path generating unit 310 can determine the region transition path, i.e. A→B→A→B, of the target video object MAN_1 according to the detected position and the time period parameter. The operating unit 312 can compare the region transition path determined by the path generating unit 310 with the region transition rule inputted by the user. When the operating unit 312 determines that the region transition path of the target video object MAN_1 in sixty seconds conforms to the region transition rule, the determining result would indicate the region transition rule is met. Accordingly, the operating unit 312 generates the corresponding determining result for the following surveillance process. For example, if the target video object MAN_1 enters the regions A and B twice in sixty seconds, this means, the target video object MAN_1 may be an abnormal customer. In such a situation, the video object detection system can generate an alarm signal to notify a supervisor of an abnormal behavior occurrence of the target video object MAN_1.

In this embodiment, the region transition label parameter and the region transition exclusion parameter can be represented by string representations of regular expressions. For example, (X→Y) represents a transition moving from a detection region X to a detection region Y. Please further refer to FIG. 9, (B→A) represents a transition from the detection region B to the detection region A, i.e. a transition from the commodity zone to the entrance and exit zone. (?→X) represents transitions moving from any region to the detection region X. The question mark symbol ? represents any region label of the detection regions on the video frame. Please further refer to FIG. 9, (?→C) represents detecting target video objects moving from any detection region to the detection region C, i.e. the warehouse zone of the shopping mall. (X→?) represents transitions moving from the transition X to any transition. Please further refer to FIG. 9, (C→?) represents detecting target video objects moving from the detection region C, i.e. the warehouse zone of the shopping mall, to any detection region.

(region transition rule)^{k} represents satisfying the marked region transition rule k times, and k is marked in superscript. Please further refer to FIG. 9, (B→A)^{k} represents detecting target video objects moved from the detection region B to the detection region A five times, i.e. moved from the commodity zone to the entrance and exit zone five times. (region transition rule)⁺ represents satisfying the marked region transition rule at least one time. The plus symbol + is marked in superscript. Please further refer to FIG. 9, (B→A)⁺ represents detecting target video objects moved from the detection region B to the detection region A at least one time, i.e. moved from the commodity zone to the entrance and exit zone at least one time. (region transition rule)* represents satisfying the marked region transition rule at least zero time. The asterisk symbol * is marked in superscript. Please further refer to FIG. 9, (B→A)* represents detecting target video objects moved from the detection region B to the detection region A at least zero time, i.e. moved from the commodity zone to the entrance and exit zone at least zero time.

(region transition rule 1)→(region transition rule 2) represents that the marked region transition rule 2 is calculated after the marked region transition rule 1. Please further refer to FIG. 9, (D→?)→(B→A) represents detecting target video objects that departed from the detection region D and further moved from the detection region B to the detection region A, i.e. departed from the check out zone and further moved from the commodity zone to the entrance and exit zone. (region transition rule 1)^{v}(region transition rule 2) represents performing a logical OR operation on the marked region transition rule 1 and the region transition rule 2. Please further refer to FIG. 9, (B→C)^{v}(B→A) represents detecting target video objects that moved from the detection region B to the detection region C or moved from the detection region B to the detection region A, i.e. moved from the commodity zone to the warehouse zone or moved from the commodity zone to the entrance and exit zone. —(region transition rule) represents performing a logic NOT operation on the marked region transition rule for excluding the marked region transition rule. Please further refer to FIG. 9, —(D→A) represents detecting target video objects that not moved from the detection region D to the detection region A, i.e. moved from the check-out zone to the entrance and exit zone.

Since the region transition label parameter and the region transition exclusion parameter are represented by string representations of regular expressions, the operating unit 312 can compare a string illustrating moving trajectory of the target video object with strings of a region transition label and a region transition exclusion label by using a string matching method, so as to detect the specific video object. As shown in FIG. 9, the region transition path of the target video object MAN_1 is “A→B→A→B”. When the user wants to set a region transition label parameter “A→B→A→B” of the region transition rule, the user can input the string “(A→B)” via the user interface unit 304. The user can also click a column “( )²” of the user interface unit 304 input the string (A→B) in the brackets of the column for realizing the input of the string “(A→B)”. Such like this, the user can input the string “(A→?→B)” via the user interface unit 304. The user can also click a column “( )²” of the user interface unit 304 input the string (A→?→B) in the brackets of the column for realizing the input of the string “(A→?→B). Besides, the user can also input the string “(A→?→B)²” or “(A→?→?→B)²” via the user interface unit 304. In other words, by using the string representations of regular expressions, the invention can provide the user to flexibly design advanced region transition rules for the following video surveillance process, so as to reduce occurrence of false alarm. In such a situation, the video object detection system 30 can rapidly obtain the target video object with specific moving trajectory via using a string matching method.

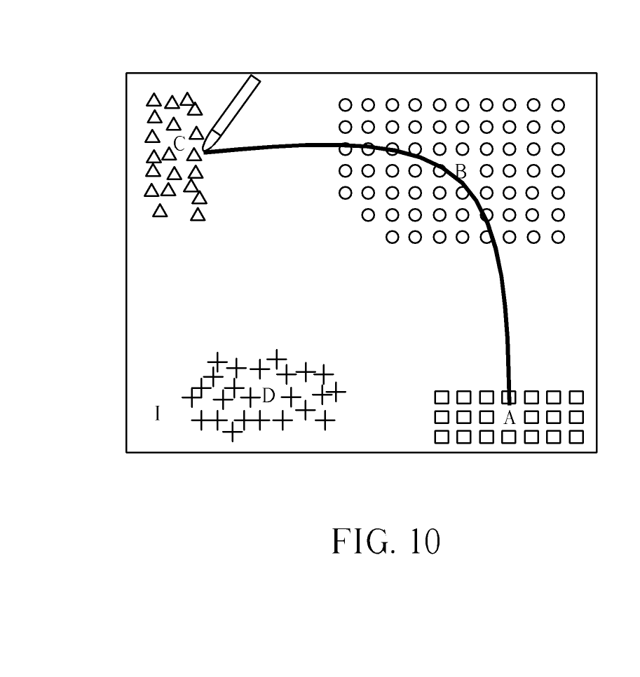

In addition, the user can also use the user interface unit 304 to draw a detection curve in the defined detection regions, such that the drawn curve can be interpreted into a region transition rule. For example, please refer to FIG. 10. When a user wants to set a region transition label parameter “A→B→C” of the region transition rule, the user draw a detection curve DC on the video frame I. The detection curve DC is then interpreted into a path “ABC” by the user interface unit 304, and the user interface unit 304 further set a region transition label parameter “A→B→C” for the region transition rule. In other words, by using the input operation with the regular expression or the graphical user interface, the user can rapidly input complicated region transition rule for the video object detection system.

In summary, since the conventional video object detection and counting system usually adopts a “detection line” for acting as a system detection interface, the conventional system may require to establish a lot of detection lines and set detection directions of detection lines for counting, thus, incurring longer setting time and more complex computations, and causing inconvenience for the user. In comparison, the invention utilizes a representation method of a sparse point set for the video object detection so as to reduce complexity of computations. Moreover, the invention provides a more rapid and convenient way for the user to define detection region via the user interface unit and determine the position of the target video object via the corresponding image pixels, and thus reducing operation time and enhancing convenience for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video object detection system based on region transition, comprising:
a video acquiring unit for acquiring a video frame;
a user interface unit configured to provide a user to define at least one detection region with a set of image pixels on the acquired video frame and to define at least one region transition rule for identifying video objects of interest, wherein each detection region is represented with a set of image pixels; and
a control module for detecting position of a target video object and determining whether a moving trajectory of the target video object matches the at least one region transition rule.

2. The video object detection system of claim 1, wherein for each detection region, the user interface unit is adapted to enable the user to adjust density of the set of the image pixels, the set of the image pixels with the lowest density at least comprises a representative image pixel of the each detection region, the set of the image pixels with the highest density at most comprises all image pixels of the each detection region.

3. The video object detection system of claim 1, wherein the user interface unit further comprises a detection region drawing module for providing the user to draw the at least one detection region and to select density of the set of the image pixels of the at least one detection region.

4. The video object detection system of claim 3, wherein the detection region drawing module comprises at least one of the following: a free hand drawing sub-module, an anchor point selection module, and a region template adjusting sub-module;
the free hand drawing sub-module for providing the user to draw the at least one detection region in a free-form shape and to select density of the set of the image pixels of the at least one detection region;
the anchor point selection module for providing the user to draw the at least one detection region in a polygon shape and to select density of the set of the image pixels of the at least one detection region; and
the region template adjusting sub-module for providing the user to draw the at least one detection region in a region partition corresponding to a specific template by adjusting control points of a region template and to select density of the set of the image pixels of the at least one detection region.

5. The video object detection system of claim 1, wherein the user interface unit further comprises a region transition rule setting module for providing the user to set the at least one region transition rule according to detection region labels.

6. The video object detection system of claim 5, wherein the region transition rule setting module comprises at least one of the following: a graphical drawing region transition sub-module and a text input region transition sub-module;
the graphical drawing region transition sub-module for providing the user to draw region transition paths via a graphical user interface, to set region transition labels and region transition exclusion labels via the graphical user interface, and to input other parameters of the at least one region transition rule on free hand drawing paths; and
the text input region transition sub-module for providing the user to set region transition labels and region transition exclusion labels via a specific text input format and to input other parameters of the at least one region transition rule on text label paths.

7. The video object detection system of claim 5, wherein the at least one region transition rule comprises at least one of the following: an object type parameter, a region transition label parameter, a time period parameter, and a region transition exclusion parameter;
the object type parameter for providing the user to assign specific object types for acting as detection targets of region transitions;
the region transition label parameter for providing the user to label sequence of the region transition;
the time period parameter for providing the user to set video objects occurring region transitions during a detection period; and
the region transition exclusion parameter for providing the user to assign exclusion conditions of the region transitions.

8. The video object detection system of claim 7, wherein the region transition label parameter and the region transition exclusion parameter are represented by string representations of regular expressions, wherein the string representations of the regular expressions comprise at least one of the following string representations defined by equation (1) to equation (8);
the equation (1) is expressed as:
X→Y (1)
wherein the equation (1) represents a transition from a detection region X to a detection region Y;
the equation (2) is expressed as:
? (2)
wherein the question mark symbol ? represents any region label of the at least one detection region on the video frame;
the equation (3) is expressed as:
(region transition rule)^{k} (3)
wherein k is marked in superscript, and the equation (3) represents satisfying the marked region transition rule k times;
the equation (4) is expressed as:
(region transition rule)⁺ (4)
wherein the plus symbol + is marked in superscript, and the equation (4) represents satisfying the marked region transition rule at least one time;
the equation (5) is expressed as:
(region transition rule)* (5)
wherein the asterisk symbol * is marked in superscript, and the equation (5) represents satisfying the marked region transition rule at least zero time;
the equation (6) is expressed as:
(region transition rule 1)→(region transition rule 2) (6)
wherein the equation (6) represents that the marked region transition rule 2 is calculated after the marked region transition rule 1;
the equation (7) is expressed as:
(region transition rule 1)^{v}(region transition rule 2) (7)
wherein the equation (7) represents performing a logical OR operation on the marked region transition rule 1 and the region transition rule 2; and
the equation (8) is expressed as:
−(region transition rule) (8)
wherein the equation (8) represents performing a logic NOT operation on the marked region transition rule for excluding the marked region transition rule.

9. The video object detection system of claim 1, wherein the control module compares a string illustrating moving trajectory of the target video object with strings of a region transition label and a region transition exclusion label by using a string matching method.

10. The video object detection system of claim 1, wherein the control module comprises:
an object detection unit for detecting position of the target video object in the video frame and then accordingly generating a position detecting result; and
a path generating unit for generating a region transition path corresponding to the target video object according to the position detecting result; and
an operating unit for determining whether the region transition path conforms to the at least one region transition rule, so as to generate a determining result.

11. A video object detection method based on region transition, comprising:
acquiring a video frame;
providing a user to define at least one detection region with a set of image pixels on the acquired video frame and to define at least one region transition rule for identifying video objects of interest via a user interface unit, wherein each detection region is represented with a set of image pixels;
detecting position of a target video object and determining whether a moving trajectory of the target video object matches the at least one region transition rule.

12. The video object detection method of claim 11, wherein for each detection region, the user utilizes the user interface unit to adjust density of the set of the image pixels, the set of the image pixels with the lowest density at least comprises a representative image pixel of the each detection region, the set of the image pixels with the highest density at most comprises all image pixels of the each detection region.

13. The video object detection method of claim 11, further comprising:
utilizing a detection region drawing module to provide the user to draw the at least one detection region and to select density of the set of the image pixels of the at least one detection region.

14. The video object detection method of claim 13, wherein the step of utilizing the detection region drawing module for providing the user to draw the at least one detection region and to select density of the set of the image pixels of the at least one detection region detection region drawing module comprises at least one of the following steps:
utilizing a free hand drawing sub-module for providing the user to draw the at least one detection region in a free-form shape and to select density of the set of the image pixels of the at least one detection region;
utilizing an anchor point selection module to provide the user to draw the at least one detection region in a polygon shape and to select density of the set of the image pixels of the at least one detection region; and
utilizing a region template adjusting sub-module to provide the user to draw the at least one detection region in a region partition corresponding to a specific template by adjusting control points of a region template and to select density of the set of the image pixels of the at least one detection region.

15. The video object detection method of claim 11, further comprising:
utilizing a region transition rule setting module to provide the user to set the at least one region transition rule according to detection region labels.

16. The video object detection method of claim 15, wherein the step of utilizing the region transition rule setting module to provide the user to set the at least one region transition rule according to detection region labels comprises at least one of the following steps:
utilizing a graphical drawing region transition sub-module to provide the user to draw region transition paths via a graphical user interface, to set region transition labels and region transition exclusion labels via the graphical user interface, and to input other parameters of the at least one region transition rule on free hand drawing paths; and
utilizing a text input region transition sub-module to provide the user to set region transition labels and region transition exclusion labels via a specific text input format and to input other parameters of the at least one region transition rule on text label paths.

17. The video object detection method of claim 15, wherein the at least one region transition rule comprises at least one of the following: an object type parameter, a region transition label parameter, a time period parameter, and a region transition exclusion parameter;
the object type parameter for providing the user to assign specific object types for acting as detection targets of region transitions;
the region transition label parameter for providing the user to label sequence of the region transition;
the time period parameter for providing the user to set video objects occurring region transitions during a detection period; and
the region transition exclusion parameter for providing the user to assign exclusion conditions of the region transitions.

18. The video object detection method of claim 17, wherein the region transition label parameter and the region transition exclusion parameter are represented by string representations of regular expressions, wherein the string representations of the regular expressions comprise at least one of the following string representations defined by equation (1) to equation (8);
the equation (1) is expressed as:
X→Y (1)
wherein the equation (1) represents a transition from a detection region X to a detection region Y;
the equation (2) is expressed as:
? (2)
wherein the question mark symbol ? represents any region label of the at least one detection region on the video frame;
the equation (3) is expressed as:
(region transition rule)^{k} (3)
wherein k is marked in superscript, and the equation (3) represents satisfying the marked region transition rule k times;
the equation (4) is expressed as:
(region transition rule)⁺ (4)
wherein the plus symbol + is marked in superscript, and the equation (4) represents satisfying the marked region transition rule at least one time;
the equation (5) is expressed as:
−(region transition rule)* (5)
wherein the asterisk symbol * is marked in superscript, and the equation (5) represents satisfying the marked region transition rule at least zero time;
the equation (6) is expressed as:
(region transition rule 1)→(region transition rule 2) (6)
wherein the equation (6) represents that the marked region transition rule 2 is calculated after the marked region transition rule 1;
the equation (7) is expressed as:
(region transition rule 1)^{v}(region transition rule 2) (7)
wherein the equation (7) represents performing a logical OR operation on the marked region transition rule 1 and the region transition rule 2; and
the equation (8) is expressed as:
−(region transition rule) (8)
wherein the equation (8) represents performing a logic NOT operation on the marked region transition rule for excluding the marked region transition rule.

19. The video object detection method of claim 11, the step of detecting position of the target video object and determining whether a moving trajectory of the target video object matches the at least one region transition rule comprising: comparing a string illustrating moving trajectory of the target video object with strings of a region transition label and a region transition exclusion label by using a string matching method.

20. The video object detection method of claim 11, the step of detecting position of the target video object and determining whether a moving trajectory of the target video object matches the at least one region transition rule comprises:
detecting position of the target video object in the video frame and accordingly generating a position detecting result; and
generating a region transition path corresponding to the target video object according to the position detecting result; and
determining whether the region transition path conforms to the at least one region transition rule, so as to generate a determining result.
